(19) United States
(12) Patent Application Publication
(10) Pub. No.: US 2006/0204059 A1
(43) Pub. Date: Sep. 14, 2006

(54) Apparatus for authenticating vehicle driver

(75) Inventors: Yusaku Ido, Kyoto-shi (JP); Shunji Ota, Kyoto-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/371,430

(22) Filed: Mar. 9, 2006

(30) Foreign Application Priority Data
Mar. 10, 2005 (JP) 2005-067256

(51) Int. Cl. G05D 1/00; G05B 19/00; G06K 9/00; H04K 1/00

(52) U.S. Cl. 382/118; 701/1; 713/186; 340/5.2; 340/5.53

(57) ABSTRACT

An authenticating apparatus has an image capturing section, such as camera, and a controller. The image capturing section captures a facial image of a first person such as a potential driver in a driver seat and a second person such as a passenger in a passenger seat. The controller compares the captured facial images with a pre-registered facial image of an authorized driver stored therein. The controller allows the first person to start an engine if any one of the captured facial images matches the pre-registered facial image.

### CROSS REFERENCE

This Nonprovisional application claims priority under 35 U.S.C. § 119(a) on Patent Application No. 2005-067256 filed in Japan on Mar. 10, 2005, the entire contents of which are hereby incorporated by reference.

### BACKGROUND OF THE INVENTION

The present invention relates to an apparatus for authenticating a driver of a vehicle such as a car.

Many types of anti-theft apparatuses have been proposed to improve security against car theft. Examples of the apparatuses include an anti-theft apparatus adapted to capture a potential driver's facial image and to compare the captured facial image with a pre-registered facial image of an authorized driver. Such apparatus is proposed in Japanese Patent Applications Laid-Open No. H11-43016A and No. 2004-330979A.

Japanese Patent Application Laid-Open No. H11-43016A discloses an anti-theft apparatus for vehicles configured to capture a facial image of a potential driver in a driver's seat, and to compare the captured facial image with a pre-registered facial image of an authorized driver. The apparatus allows the driver to start an engine if a match of facial images between the authorized driver and the potential driver is made.

Japanese Patent Application Laid-Open No. 2004-330979A discloses an apparatus for vehicles configured to capture a facial image of a driver in a driver seat, and to compare the captured facial image with a pre-stored facial image of an authorized driver. If a match of facial images between the authorized driver and the potential driver is made, the apparatus allows the driver to start an engine under the condition that the driver's face is oriented in a proper direction.

However, all proposed apparatuses suffer from the inherent disadvantage that the apparatuses prevent an authorized driver from leaving the driving to an accompanying passenger. Since the apparatuses capture and analyze only a facial image of person in the driver seat, the apparatuses do not allow an unauthorized person, i.e. those who are not registered as an authorized driver, to start an engine even if the authorized driver is in a passenger seat.

If the authorized driver is to leave the driving to an accompanying passenger, the apparatuses require a separate procedure such as registration of the passenger's facial image, thereby causing inconveniences.

A feature of the invention is to provide an authenticating apparatus adapted to allow an unauthorized person to start an engine under the condition that match of facial images between an authorized driver and an accompanying passenger is made.

### SUMMARY OF THE INVENTION

An apparatus for authenticating a driver of a vehicle according to the present invention is provided with an image capturing section adapted to capture a facial image of a second person such as a passenger in a passenger seat as well as that of a first person such as a potential driver in a driver seat.

The apparatus is also provided with a controller adapted to compare the captured facial images with a pre-registered facial image of an authorized driver, and to allow the first person to start an engine if either one of the captured facial images matches the facial image of the authorized driver. Capturing facial images of the first and second persons can be done by the image capturing section, simultaneously or separately.

When capturing the facial images simultaneously, the image capturing section is adapted to have a lens having such an angle of view that facial images of the first and second persons are captured at one time. Generally, the image capturing section is adapted to have a wide-angle lens. If a vehicle is a car, it's preferable that the image capturing section is disposed adjacent to an interior rear view mirror.

According to another aspect of the invention, the controller first compares the facial image of the first person with the facial image of the authorized driver. Then, in the event that the image of the first person does not match the facial image of the authorized driver, the controller compares the facial image of the second person with the facial image of the authorized driver.

This configuration allows a shortened processing time, since in many cases the facial image of the first person is expected to match a facial image of the authorized driver.

According to another aspect of the invention, the image capturing section and the controller are activated by predetermined triggers.

Examples of the predetermined triggers include, but are not limited to, a signal fed from a door sensor disposed adjacent to a vehicle seat and a signal fed from a seat sensor for detecting a presence of a person in a vehicle seat.

The door sensor generates a trigger signal when detecting that a vehicle door is closed. The seat sensor generates a trigger signal when detecting the presence of a person in a vehicle seat.

Adjusting an angle of view enables the image capturing section to capture facial images of the first and second persons in the respective driver and front passenger seats, or to capture a facial image of a person in the back passenger seat as well as the facial images of the first and second persons.

In the present invention, the term “authenticating a driver” refers to verifying whether a person in a driver seat is authorized to start an engine.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a schematic diagram of a car employing an authenticating apparatus according to an embodiment of the invention;

FIG. 2 is a schematic diagram of an arrangement of a camera;

FIG. 3 is a block diagram of the authenticating apparatus; and

FIG. 4 is a flow chart of a process performed by the authenticating apparatus.

### DETAILED DESCRIPTION OF THE PREFERRED EMBODIMENTS

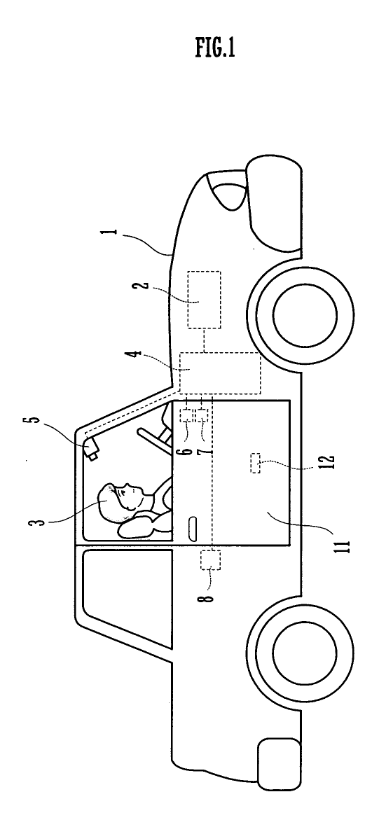

FIG. 1 illustrates a vehicle, such as a car 1, provided with an authenticating apparatus such as a driver authenticating apparatus.

The car 1 includes an engine controller 2 connected to an ignition switch (not shown).

As in the case of a conventional car, a first person such as a potential driver (herein after referred to merely as the driver) 3, inserts a key into a receptacle of the ignition switch before starting an engine.

The engine controller 2 connects to a controller 4 configured to perform image authentications. The controller 4 connects to a CMOS camera 5, a registration switch 6, an enable switch 7, and a door sensor 8.

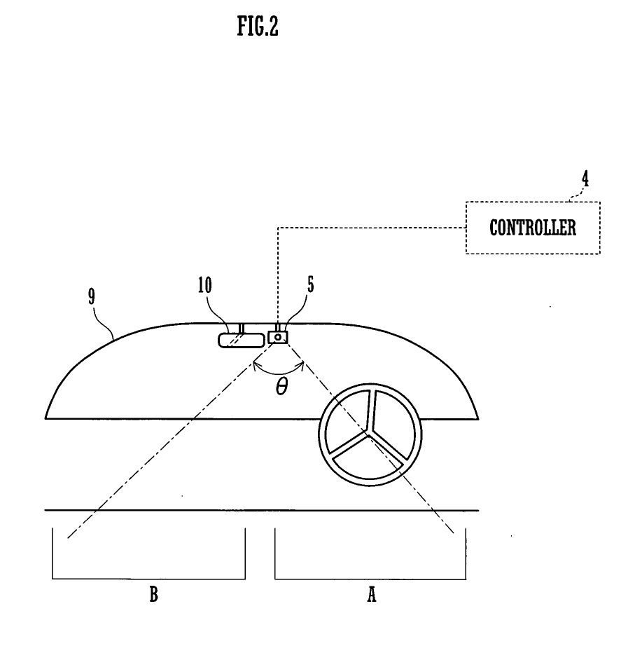

The CMOS camera 5 is a logarithmic transformation type camera with wide dynamic range. The CMOS camera 5 is mounted on an upper part of a windshield 9, as illustrated in FIG. 2. The CMOS camera 5 is disposed adjacent to an interior rear-view mirror 10 that is also mounted on an upper part of the windshield 9.

As illustrated in FIG. 2 as dashed line, the CMOS camera 5 is adapted to have an angle of view so as to cover scenes of both a driver seat A and a front passenger seat B, thereby enabling the CMOS camera 5 to capture facial images of persons in the respective seats.

The registration switch 6 is adapted to permit a driver or a front passenger to register a facial image thereof. Turning on the switch 6 causes the controller 4 to store a facial image being captured by the CMOS camera 5 in a registration memory (registration section) disposed in the controller 4.

More specifically, the controller 4 stores in the registration memory a computed feature data representing a facial feature of the captured facial image. Examples of match of facial images include, but are not limited to, a match of computed feature data of respective facial images.

The enable switch 7 is adapted to permit a driver or a passenger to enable or disable respective functions of the CMOS camera 5 and the controller 4. Turning on the enable switch 7 causes the functions of the CMOS camera 5 and the controller 4 to be in enabled state.

The door sensor 8 is adapted to detect whether the door 11 is in an open state or a closed state. The controller 4 activates the CMOS camera 5 and an image verifying section disposed in the controller 4, when the door sensor 8 detects that the door 11 shifts to the closed state from the open state.

The door sensor 8 can be replaced with a seat sensor 12 adapted to sense weight of a person applied to a seat. In the event that the seat sensor 12 is applied to the car 1, the CMOS camera 5 and the image verifying section are activated when the seat sensor 12 senses weight of a person applied to a seat.

Alternatively, a door sensor 8 or a seat sensor 12 may be provided adjacent to each of the driver seat and the front passenger seat. The CMOS camera 5 and the controller 4 may be activated when the door sensors 8 detect that the both doors shift to closed state or when the seat sensors detect that the driver and the passenger sit down on the respective driver and passenger seats.

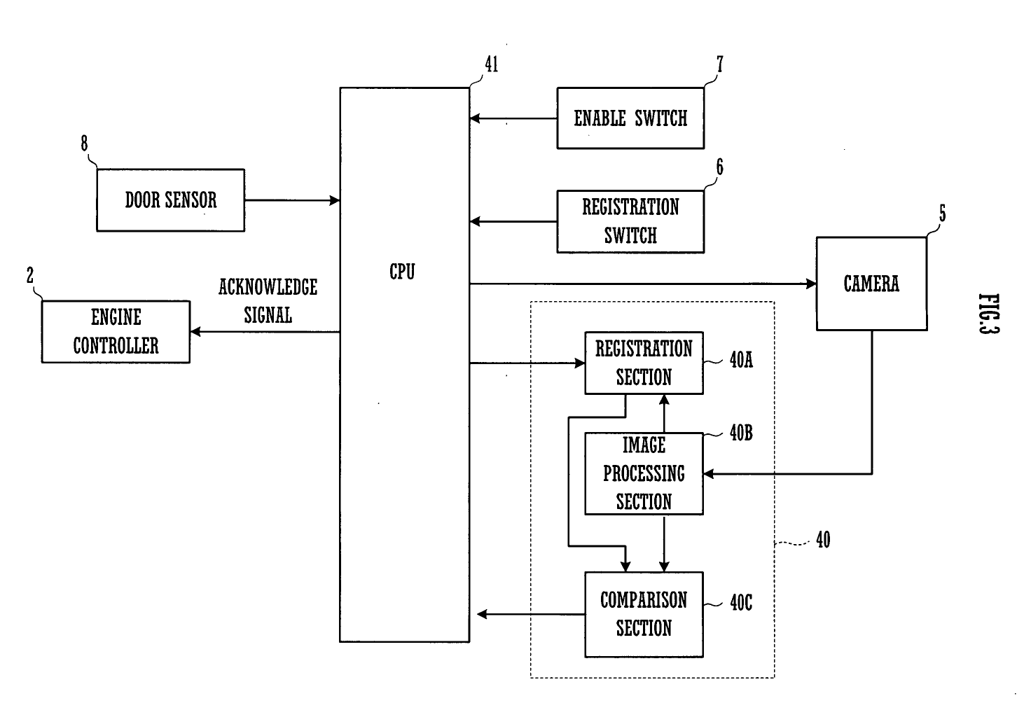

FIG. 3 is a block diagram of the authenticating apparatus. The controller 4 is provided with an image verifying section 40 and a CPU 41. Each one of the registration switch 6, the function switch 7, the door sensor 8, and the engine controller 2 is connected to the CPU 41. The CMOS camera 5 is connected to the CPU 41 and to the image verifying section 40.

The image verifying section 40 is connected to the CPU 41. The image verifying section 40 includes a registration section 40A, an image processing section 40B, and a comparison section 40C. In a registration process, the registration section 40A is adapted to register computed feature data corresponding to a facial image captured by the CMOS camera 5.

The image processing section 40B is adapted to extract computed feature data from a facial image captured by the CMOS camera 5. The image processing section 40B feeds the data to the registration section 40A in the registration process, or to the comparison section 40C in the authenticating process. The comparison section 40C is adapted to compare the computed feature data fed from the image processing section 40B with a computed feature data corresponding to a pre-registered facial image stored in the registration section 40A. In other words, the comparison section 40C compares the captured facial image with the pre-registered facial image in the authenticating process.

The comparison section 40C feeds a comparison result to the CPU 41. The CPU 41 outputs an acknowledge signal to the engine controller 2, if a match of the respective facial images is declared. Upon receipt of the acknowledge signal, the engine controller 2 permits a potential driver to start an engine with an ignition switch.

The image processing section 40B extracts computed feature data in a process such as described below.

(1) The image processing section 40B extracts a facial image from an entire scene captured by the CMOS camera 5, by distinguishing density gap between a facial area and a background. If a captured image is a color image, a facial image is extracted from the entire scene by distinguishing a skin colored area.

(2) Then, the image processing section 40B searches the extracted image of (1) for distinguishable facial parts such as an eye, a nose, and a mouth.

After completion of the search, center points and edge points of the respective facial parts are detected.

(3) The image processing section 40B detects a geometric positional relation of the facial parts in accordance with the center points and edge points, and computes feature data corresponding to the geometric positional relation.

The method of extracting a facial image by distinguishing a skin colored area is described, for example, in Japanese Patent application laid open No. 2004-20666A, the disclosure of which is incorporated herein by reference.

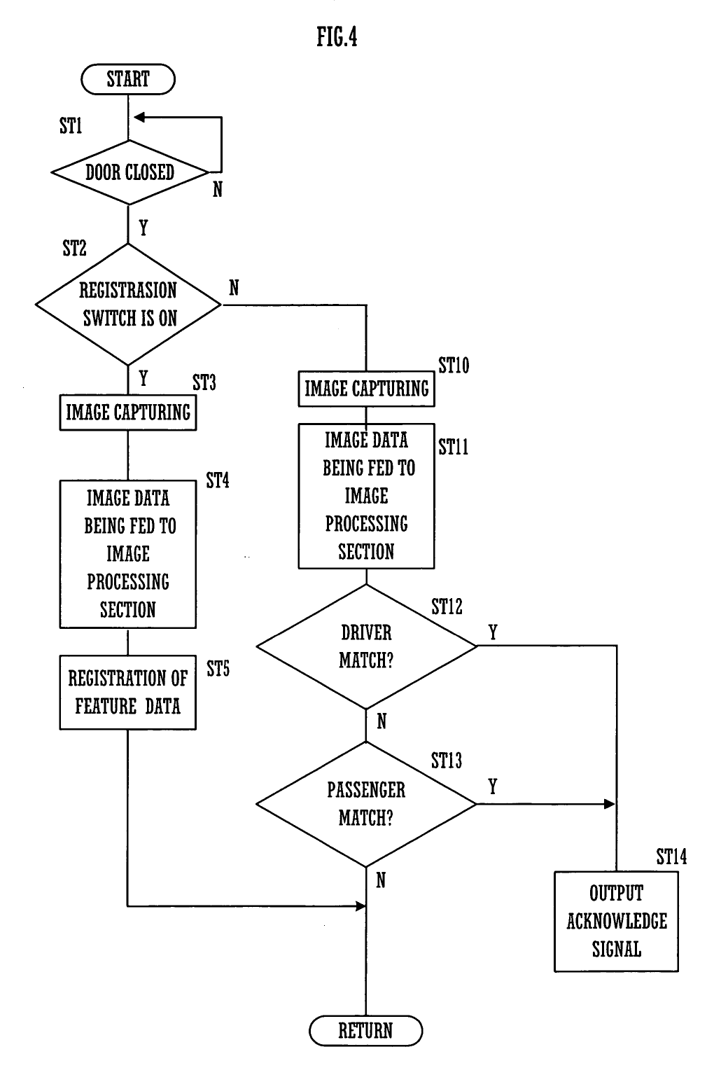

Described below with reference to FIG. 4 is an operation performed by the driver authenticating apparatus. When the door sensor 8 detects that either one of the doors adjacent to respective driver and passenger seats at step ST1, the controller 4 judges that either one of a driver and a passenger is seated and moves on to step ST2.

The controller 4 judges whether the registration switch 6 is turned on (ST2).

When the switch 6 is turned on at step ST2, the controller 4 shifts to a registration mode for registering a facial image. On the contrary, when the switch 6 is not turned on at step ST2, the controller 4 shifts to a facial recognition mode.

In the registration mode, a facial image of a driver or a front passenger is captured by the CMOS camera 5 (ST3), and the captured image is fed to the image processing section 40B (ST4).

The image processing section 40B extracts the feature data from the captured facial image. The extracted feature data is registered in the registration section 40A (ST5).

Described above is a situation where either one of a driver and a front passenger sits down on a seat and turns on the switch 6.

The configuration according to the embodiment enables any one of facial images of a driver and a front passenger to be registered. Alternatively, a controller that registers only a driver's facial image may be used in the registration mode.

When the switch 6 is not turned on at step ST2, the controller 4 shifts to the facial recognition mode and move onto step ST10. At step ST10, the CMOS camera 5 captures facial images of a driver and a passenger. In the facial recognition mode, the CMOS camera 5 captures facial images of both a driver and a front passenger at one time.

The captured facial images (image data) are fed to the image processing section 40B. Then the image processing section 40B extracts computed feature data of the facial images (ST11).

For example, the image processing section 40B extracts feature data of a driver and a front passenger when the driver and the front passenger are seated in the respective driver and passenger seats.

The captured facial image of the driver is compared with a authorized facial image pre-registered in the registration section 40A. If match of the facial images is made, the acknowledge signal is fed to the engine controller 2 (ST14).

The potential driver's facial image is compared with all authorized facial images registered in the registration section 40A. If the match is not made, then the captured facial image of the front passenger is compared with the authorized facial image at the comparison section 40C. If match of the facial images between the front passenger and the authorized driver is made, the acknowledge signal is fed to the engine controller 2 (ST14).

If neither the driver' facial image nor the front passenger's facial image matches the authorized facial image stored in the registration section 40A, the controller 4 moves back to step ST1 without outputting the acknowledge signal.

The steps shown in FIG. 4 are not performed, with the enable switch 7 turned off. Accordingly, with the enable switch 7 turned off, the engine is started every time the ignition switch is turned on.

As mentioned above, the CMOS camera 5 is a logarithmic transformation type CMOS camera. Employing this type of camera widens a dynamic range, and enables a facial image to be extracted from an entire captured image, even if the captured image is a dark image with an unclear contrast.

The foregoing embodiments are illustrative in all points and should not be construed to limit the present invention. The scope of the present invention is defined not by the foregoing embodiment but by the following claims. Further, the scope of the present invention is intended to include all modifications within the meanings and scopes of claims and equivalents.

What is claimed is:

1. An apparatus for authenticating a driver of a vehicle, the apparatus comprising:
an image capturing section adapted to capture facial images of a first person in a driver seat and a second person in a passenger seat;
a controller adapted to compare the captured facial images with a pre-registered facial image of an authorized driver, and to allow the first person to start an engine if any one of the captured facial images matches the facial image of the authorized driver.

2. The authenticating apparatus according to claim 1,
wherein the controller is adapted first to compare the facial image of the first person with the facial image of the authorized driver, and then, in the event that the first person's facial image does not match the authorized driver's facial image, to compare the facial image of the second person with the facial image of the authorized driver.

3. The authenticating apparatus according to claim 1, further comprising a door sensor mounted on a door of the vehicle, the door sensor being adapted to detect whether the door is in an open state or a closed state,
wherein the image capturing section and the controller are activated when the door sensor detects that the door shifts to the closed state from the open state.

4. The authenticating apparatus according to claim 1, further comprising a seat sensor for detecting presence of a person in a vehicle seat,
wherein the image capturing section and the controller are activated when the seat sensor detects the presence of the person in the vehicle seat.

5. The authenticating apparatus according to claim 1,
wherein each of the captured facial images and the authorized driver's facial image is represented as computed feature data corresponding to geometric positional relations among facial parts.

6. The authenticating apparatus according to claim 5,
wherein the controller extracts the computed feature data from the captured facial image.

7. The authenticating apparatus according to claim 1,
wherein the image capturing section has such an angle of view that the facial images of the first person and the second person in a front passenger seat are captured at one time.

8. The authenticating apparatus according to claim 7,
wherein the image capturing section has such an angle of view that respective facial images of the first and second persons and a third person in a back passenger seat are captured at one time.
